(19) United States
(12) Patent Application Publication
(10) Pub. No.: US 2014/0158663 A1
(43) Pub. Date: Jun. 12, 2014

(54) SURFACE TREATMENT METHOD FOR FLEXIBLE SUBSTRATE

(71) Applicant: E Ink Holdings Inc., Hsinchu (TW)

(72) Inventors: Lih-Hsiung Chan, Hsinchu (TW); Huai-Cheng Lin, Hsinchu (TW); Ming-Sheng Chiang, Hsinchu (TW); Chih-Cheng Wang, Hsinchu (TW)

(73) Assignee: E Ink Holdings Inc., Hsinchu (TW)

(21) Appl. No.: 13/961,840

(22) Filed: Aug. 7, 2013

(30) Foreign Application Priority Data
Dec. 11, 2012 (TW) 101146713

(51) Int. Cl. B29C 59/14

(52) U.S. Cl. CPC B29C 59/14
USPC 216/38

(57) ABSTRACT

A surface treatment method for a flexible substrate is provided. A flexible insulation substrate is provided. A surface of the flexible insulation substrate has at least one defect. A plasma etching is performed on the flexible insulation substrate to smooth a profile of the defect.

### CROSS-REFERENCE TO RELATED APPLICATION

This application claims the priority benefit of Taiwan application serial no. 101146713, filed on Dec. 11, 2012. The entirety of the above-mentioned patent application is hereby incorporated by reference herein and made a part of this specification.

### BACKGROUND OF THE INVENTION

1. Field of the Invention

The invention relates to a surface treatment method, and more particularly, to a surface treatment method for a flexible substrate.

2. Description of Related Art

Flexible substrates have wider applications than regular rigid substrates. The advantages of a flexible substrate are rollable, lightweight, portable, safety approved, and applied in a wide product range.

In the current fabrication technique for a flexible substrate, since the surface of the flexible substrate is not as clean or as flat as the original glass substrate, small scratches, protrusions, or cavities may form. Therefore, a thin film transistor subsequently formed on the surface of the flexible substrate may easily cause structural damage or reduce the reliability during the fabrication processes due to the above defects. Therefore, how to effectively correct surface defects on a flexible substrate is a key topic in the flexible substrate industry.

### SUMMARY OF THE INVENTION

The invention provides a surface treatment method for a flexible substrate to smooth a defect on a surface of the flexible substrate so as to improve a subsequent process yield and product reliability.

The invention provides a surface treatment method for a flexible substrate. The method includes the following steps. A flexible insulation substrate is provided. A surface of the flexible insulation substrate has at least one defect. A plasma etching is performed on the flexible insulation substrate to smooth a profile of the defect.

In an embodiment of the invention, a material of the flexible insulation substrate includes, for instance, polyethylene terephthalate (PET), polyimide (PI), or polyethylene naphthalate (PEN).

In an embodiment of the invention, a power of a plasma etching is between 100 watts and 2000 watts.

In an embodiment of the invention, a reactive gas in the plasma etching includes oxygen, oxygen mixed sulfur hexafluoride, or oxygen mixed inert gas.

In an embodiment of the invention, a flow rate range of the reactive gas in the plasma etching is between 50 sccm and 1000 sccm.

In an embodiment of the invention, the defect includes at least one protrusion or at least one cavity.

Based on the above, since the invention smoothes the defect on the flexible insulation substrate using a plasma etching, a height difference between the surface of the flexible insulation substrate and the defect is reduced. That is, the surface of the flexible insulation substrate is planarized, and the subsequent process yield and product reliability are improved.

In order to make the aforementioned features and advantages of the invention more comprehensible, embodiments accompanied with figures are described in detail below.

### BRIEF DESCRIPTION OF THE DRAWINGS

The accompanying drawings are included to provide a further understanding of the invention, and are incorporated in and constitute a part of the specification. The drawings illustrate embodiments of the invention and, together with the description, serve to explain the principles of the invention.

FIG. 1A to FIG. 1B are schematic cross-sectional diagrams illustrating a surface treatment method for a flexible substrate according to an embodiment of the invention.

FIG. 2A to FIG. 2B are schematic cross-sectional diagrams illustrating a surface treatment method for a flexible substrate according to another embodiment of the invention.

### DESCRIPTION OF THE EMBODIMENTS

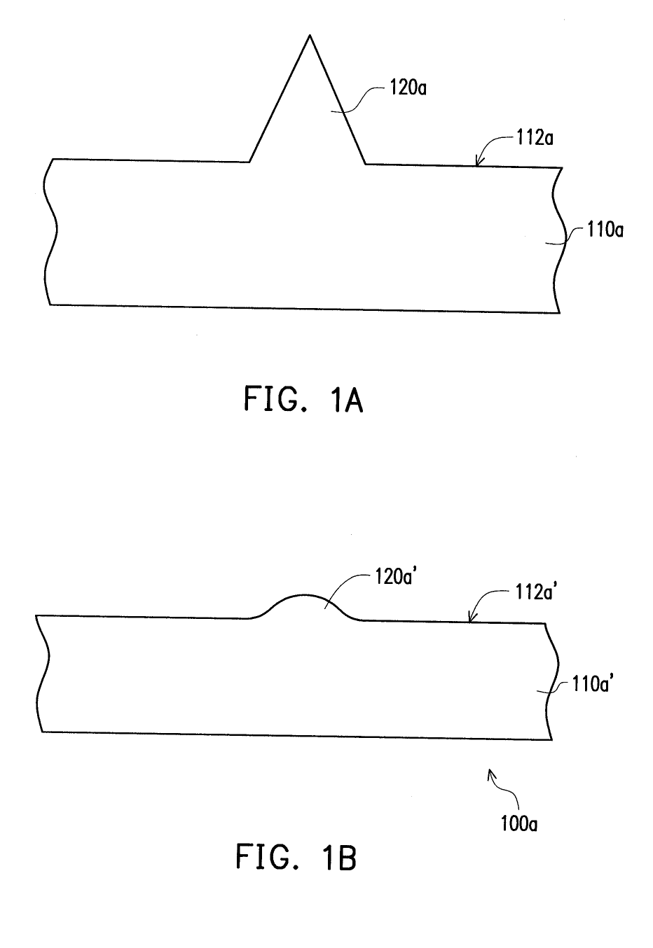

FIG. 1A to FIG. 1B are schematic cross-sectional diagrams illustrating a surface treatment method for a flexible substrate according to an embodiment of the invention. Referring to FIG. 1A, according to the surface treatment method for a flexible substrate of the embodiment, a flexible insulation substrate 110a is first provided, wherein a surface 112a of the flexible insulation substrate 110a has at least one defect 120a. A material of the flexible insulation substrate 110a is, for instance, polyethylene terephthalate (PET), polyimide (PI), or polyethylene naphthalate (PEN). The defect 120a is, for instance, at least one protrusion (only one is schematically illustrated in FIG. 1A). As illustrated in FIG. 1A, the defect 120a is a protrusion having a sharp end, but is not limited thereto.

Then, referring to FIG. 1B, a plasma etching is performed on the flexible insulation substrate 110a to smooth a profile of the defect 120a. In detail, the embodiment uses an anisotropic etching characteristic of the plasma etching to repair the defect 120a on the flexible insulation substrate 110a within a reaction time in order to reduce a height difference between the surface 112a of the flexible insulation substrate 110a and the defect 120a. As illustrated in FIG. 1B, a thickness of the flexible insulation substrate 110a′ after the plasma etching is less than the thickness of the prior flexible insulation substrate 110a without the plasma etching. After the defect 120a (for instance a protrusion having a sharp end) is plasma etched, a defect 120a′ having a planarized surface is formed. That is, the sharp end of the original defect 120a became smooth so a space between the defect 120a′ and a surface 112a′ of the flexible insulation substrate 110a′ is planarized, and a flexible substrate 100a having a flat surface is formed.

More specifically, a power of a plasma etching of the embodiment is between 100 watts and 2000 watts, a reactive gas in the plasma etching includes oxygen, oxygen mixed sulfur hexafluoride, or oxygen mixed inert gas, and a flow rate range of the reactive gas in the plasma etching is between 50 sccm and 1000 sccm.

Since the embodiment uses the plasma etching to smooth the defect 120a of the flexible insulation substrate 110a, the flexible insulation substrate 110a′ having a planarized defect 120a′ is formed. In this way, the height difference between the surface 112a′ of the flexible insulation substrate 110a′ and the defect 120a′ is reduced. That is, the surface 112a′ of the flexible insulation substrate 110a′ is planarized, therefore a fabrication of subsequent active components (for instance a thin film transistor) on the surface 112a′ of the flexible insulation substrate 110a′ is more stable, and a process yield and product reliability are improved.

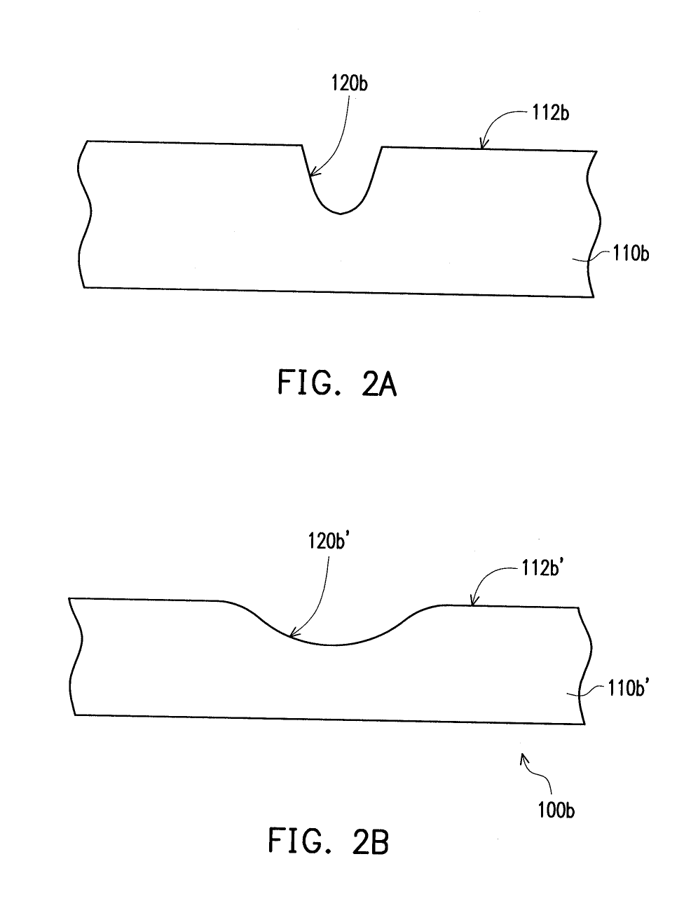

It should be mentioned that, a form of the defect 120a is not limited by the invention, although the embodied defect 120a is a protrusion having a sharp end. However, in other embodiments, referring to FIG. 2A, a defect 120b may also be at least one cavity (only one is schematically illustrated in FIG. 2A), wherein in essence a junction of the defect 120b and a surface 112b of a flexible insulation substrate 110b has an edge. After a plasma etching, referring to FIG. 2B, the space between a defect 120b′ and a surface 112b′ of a flexible insulation substrate 110b′ is planarized. That is, the profile of the defect 120b′ is smoothed to reduce the height difference between the surface 112b′ of the flexible insulation substrate 110b′ and the defect 120b′, and a flexible substrate 100b having a flat surface is formed. Or, in other unillustrated embodiments, the defect may also be composed of protrusions and cavities. In short, the invention does not limit the forms of the defects 120a and 120b. The forms of the defects 120a and 120b are within the scope of the invention to be protected, provided that a plasma etching is used to smooth the surfaces 112a and 112b of the flexible insulation substrates 110a and 110b.

Based on the above, since the invention smoothes the defect on the flexible insulation substrate using the plasma etching, the height difference between the surface of the flexible insulation substrate and the defect is reduced. That is, the surface of the flexible insulation substrate is planarized, and the subsequent process yield and product reliability are improved.

Although the invention has been described with reference to the above embodiments, it will be apparent to one of the ordinary skill in the art that modifications and variations to the described embodiments may be made without departing from the spirit and scope of the invention. Accordingly, the scope of the invention will be defined by the attached claims not by the above detailed descriptions.

What is claimed is:

1. A surface treatment method for a flexible substrate comprising:
providing a flexible insulation substrate, wherein a surface of the flexible insulation substrate has at least one defect; and
performing a plasma etching on the flexible insulation substrate to smooth a profile of the defect.

2. The surface treatment method for the flexible substrate as recited in claim 1, wherein a material of the flexible insulation substrate comprises polyethylene terephthalate, polyimide, or polyethylene naphthalate.

3. The surface treatment method for the flexible substrate as recited in claim 1, wherein a power of the plasma etching is between 100 watts and 2000 watts.

4. The surface treatment method for the flexible substrate as recited in claim 1, wherein a reactive gas in the plasma etching comprises oxygen, oxygen mixed sulfur hexafluoride, or oxygen mixed inert gas.

5. The surface treatment method for the flexible substrate as recited in claim 4, wherein a flow rate range of the reactive gas in the plasma etching is between 50 sccm and 1000 sccm.

6. The surface treatment method for the flexible substrate as recited in claim 1, wherein the at least one defect comprises at least one protrusion or at least one cavity.
